(19) United States
(12) Patent Application Publication
(10) Pub. No.: US 2015/0211203 A1
(43) Pub. Date: Jul. 30, 2015

(54) MODULAR FOUNDATION RESISTANT TO GROUND MOVEMENT

(71) Applicant: Charles Caulder Bree, Mercer (NZ)

(72) Inventor: Charles Caulder Bree, Mercer (NZ)

(21) Appl. No.: 14/405,157

(22) PCT Filed: Jun. 5, 2012
(86) PCT No.: PCT/NZ2012/000082

§ 371 Date: Apr. 20, 2015

(51) Int. Cl. E02D 27/34; E02D 27/02; B29C 41/04; E02D 27/01

(52) U.S. Cl. CPC E02D 27/34; E02D 27/016; E02D 27/02; B29C 41/04; E02D 2200/11; E02D 2250/0007; B29D 23/00

(57) ABSTRACT

One or more modules are each moulded as single units. Separately or fastened together they form a foundation resistant to ground movement including earthquakes and frost heave. A lower plane rests on a substrate. Perimeter and internal walls support a raised upper plane for receiving a building such as a rotationally moulded round house. Modules are made of reinforced concrete or rotationally moulded plastics and enclose internal cavities used as tanks or filled with a rigid foam. Lifting attachments are provided for transport of modules or temporary foundation lifting during rearrangement of a disturbed substrate.

### FIELD

This invention relates to base structures for buildings, preferably but not limited to prefabricated modular buildings, wherein the base structures or foundation pads effectively support the building or buildings on soil or other substrates and are relatively resistant to soil movement such as arise from seismic activity or freezing.

### BACKGROUND

The inventor has already published a number of inventions for a circular plan house of the order of 5 metres diameter, made by rotational moulding of a fusible plastics material in a single forming process in a rotating oven. The inventor's PCT/NZ2008/000096 describes that apparatus and process. Later developments include assemblies of straight and curved panels in order to create larger enclosed spaces.

Houses of all types require a firm foundation at all times. There have been many reports of substrate failure, popularly called liquefaction although a more accurate term is dewatering or compaction, which has resulted in a suspension of silt rising above the soil surface and flowing into houses in parts of Christchurch, New Zealand, during seismic damage in 2010-2011. Many house foundations have broken irreparably. Their construction was not strong enough to withstand imposed forces which may include twisting as well as unidirectional forces. In Port-au-Prince, Haiti, in 2010, earthquake damage devastated the city.

The prior art includes one-piece rib rafts made using reinforced concrete, in which a steel structure is placed on a substrate and surrounded by concrete retaining means, while internal stiffening ribs extending down to the substrate are surrounded by concrete excluding means such as cardboard boxes or blocks of polystyrene foam. Then a mass of wet concrete is poured over the steel and the upper surface, including reinforcing, is smoothed and then allowed to set and cure. In this, there is no continuous lower surface.

There is a need to devise and provide a firm foundation that is (a) significantly stronger than what was considered acceptable prior to the onset of repeated seismic activity, and (b) configured to the shape of a rotationally moulded house or a part of one.

Further, there is a need to provide a firm foundation for a rotationally moulded house which is made of compatible materials; that is, a fusible plastics material, with those used for the structure of the house itself. If the firm foundation is made transportable then the house can be used as a temporary dwelling such as for refugees.

### OBJECT

To provide a strong foundation having a thickness and an ability to include liquid storage means, for a house especially a prefabricated modular house, or at least to provide the public with a useful choice. In an alternative, to provide a foundation for a building which can be lifted and made level again after a soil movement event, and which is relatively unlikely to receive structural damage during that event.

### SUMMARY OF INVENTION

In a first broad aspect the invention provides a foundation, comprised of one or more modules for a building wherein the or each module includes a broad, rigid, reinforced lower surface having, when in place, an exposed lowest face and an interior face, upon which surface are simultaneously moulded or cast at least one rigid separating means selected from a range including peripheral beams, internal vertical protrusions and transverse ribs, all sharing a common height thereby determining the height of at least one space enclosed within the foundation, and upon which separating means a broad, rigid, reinforced upper surface is moulded or cast; the upper surface having an interior face and an uppermost exposed face; the or each module including attachment means.

Preferably the lower surface, the separating means, and the upper surface are moulded or cast sufficiently simultaneously that all parts form a cohesive mass.

In a related aspect, the foundation is comprised of more than one module, all modules being fastened together by attachment means along exposed sides in order to form a larger total surface area.

Preferably at least some modules are provided with lifting attachments capable of being used to lift the foundation and a building attached thereto.

Optionally the or each enclosed space is sealed, thereby forming a tank, and is provided with a sealable aperture in order that the tank may be filled and emptied with a fluid.

In one alternative a previously manufactured tank is sealed into the enclosed space.

In another alternative the or each enclosed space is filled with an inert, foamed material.

In a further alternative, a space used for a tank includes a foam base so that the contents of the tank are less liable to freeze.

In a first aspect, each module is comprised of poured concrete, the lower surface, upper surface, and rigid separating means being reinforced by provision of internal, elongated metal rods in order to provide a tensile strength.

In a second aspect, the first and the second surfaces and rigid separating means are comprised of a rotationally moulded plastics material, optionally reinforced by thickening in appropriate places, and the first and the second surfaces and the separating means are moulded as a single unit.

In a related aspect the or each space having a height is traversed by at least one internal rigid member made at least in part of a rotationally moulded plastics material capable when in use of transmitting a load from the upper surface to the lower surface.

Optionally a module for the foundation includes one or more termination sites at which external services selected from a range including potable water, sewage, storm water, electricity, cable, telephone, and gas may be reversibly connected.

In a second broad aspect the invention provides a rotational moulding method whereby said at least one internal rigid beam is provided within a rotationally moulded foundation module by a method including the steps of providing a mould having an upper and a lower shell; each shell including a plurality of matching apertures; one at the site of each internal rigid beam, and a plurality of thermally conductive metal rods each having a greater length than the height of the final internal space; and a plurality of thermoplastics plastic pipes each having a selected softening temperature such that it will bond with the selected thermoplastics powder and a length equal to the height of the internal space and is placed over each conductive metal rod inside the mould, and the steps of
a) placing one conductive metal rod through each aperture in one shell of the mould,
b) placing one plastics pipe over each conductive metal rod inside the mould,
c) closing the two shells of the mould, ensuring that the conductive metal rods are exteriorised through corresponding apertures in both shells,
d) rotating the mould within a heated oven, so that an inserted mass of thermoplastics powder will fuse together over the interior of the mould and fuse with the thermoplastic pipes and form an enclosed space inside the mould, bridged by a plurality of closed plastics pipes, and
e) parting the mould after cooling has occurred, removing the metal rods for re-use, and removing the module from the mould

### PREFERRED EMBODIMENT

The examples described and illustrated herein are given by way of example, but are not to be taken as limiting the scope or spirit of the invention. In particular, the nomenclature of “upper” and “lower” reflects a usual orientation. Throughout this specification unless the text requires otherwise, the word “comprise” and variations such as “comprising” or “comprises” will be understood to imply the inclusion of a stated integer or step or group of integers or steps but not the exclusion of any other integer or step or group of integers or steps. Each document, reference, patent application or patent cited in this text is expressly incorporated herein in their entirety by reference. Reference to cited material or information cited in the text should not be understood as a concession that the material or information was part of the common general knowledge or was known in New Zealand or in any other country.

### DRAWINGS

FIG. 1: is a plan view of an Example 1 (concrete) type foundation for a round house.

FIG. 1a: is a plan view of an Example 1 (concrete) type foundation for a rectangular house.

FIG. 2: is a vertical section through the Example 1 foundation.

FIG. 3: shows details of steel reinforcing within part of a vertical section of the Example 1 foundation.

FIG. 4: shows a vertical section of an Example 2 (plastic) foundation under a rotationally moulded house; including one or more built-in tanks.

FIG. 5: is a plan view of an Example 2 type foundation moulded in several parts.

FIG. 6: is a perspective view of a stiffened tank and foundation according to Example 2.

FIG. 7: shows detail of a stiffening member after moulding.

### EXAMPLE 1

The invention aims to provide a foundation 100 having significantly greater strength than that of existing slab, raft or pile foundations. According to this invention, a light yet strong foundation is intended to protect both itself and the building on top by providing a rigid base capable of bridging a subsequently formed space (which may appear by collapse or by lateral spreading) without significant deformation. Soil heaving is a common phenomenon in permafrost areas and a stiff foundation capable of riding a soil heave without structural failure is desired. If the overall mass or weight of the building and its foundation is not too great, yet the foundation has a sufficient volume, a buoyancy effect should prevent the building from sinking into the soil during “liquefaction”. The inventor's objective is to provide a building or at least a foundation for a building which can be lifted and made level again after a soil movement event, and which is relatively unlikely to receive structural damage during that event.

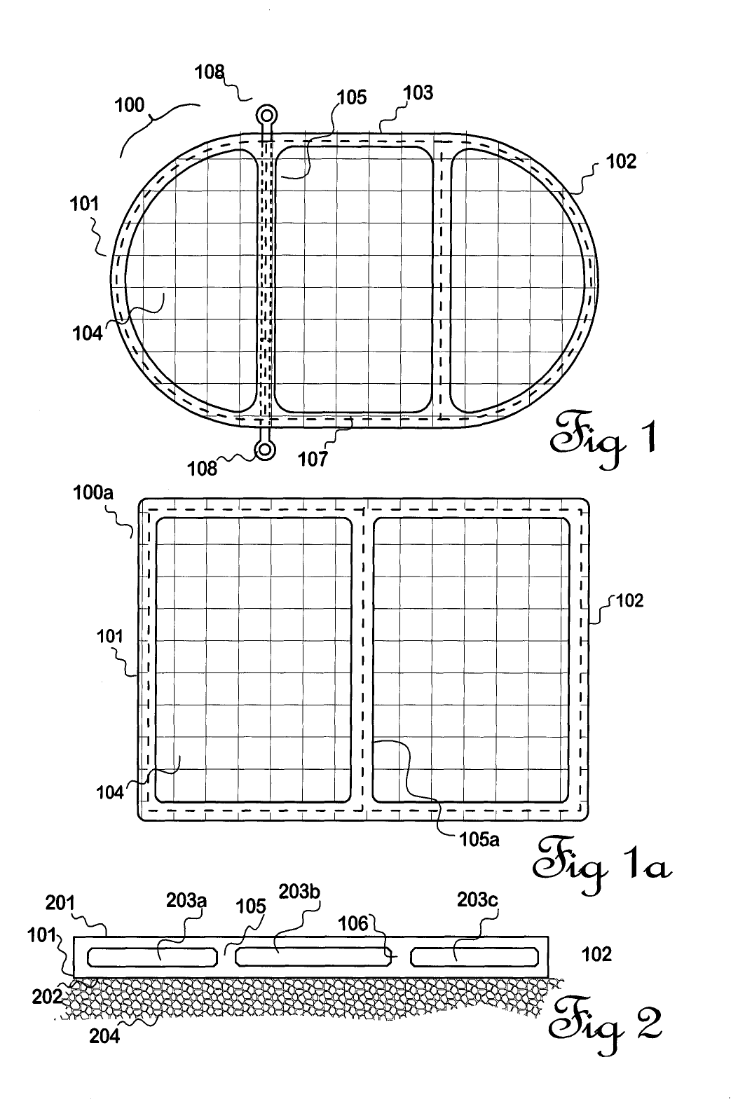

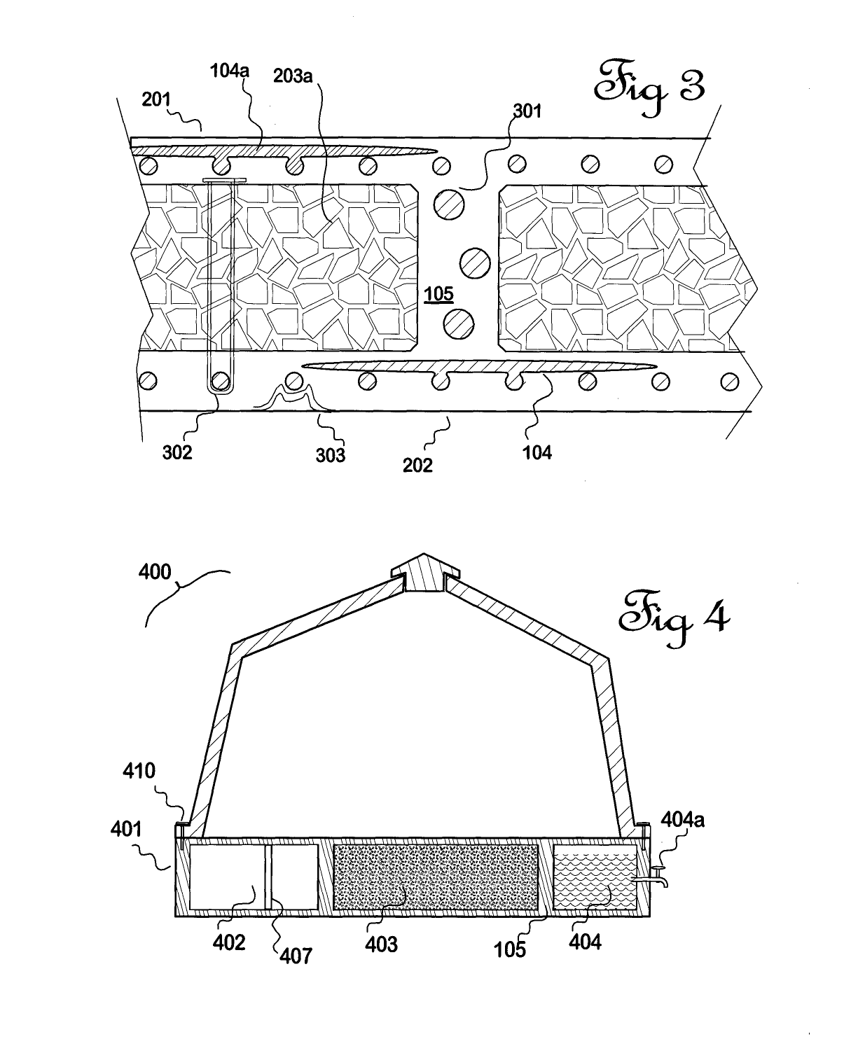

See FIGS. 1, 1a, 2 and 3. Use of rigid and enclosed or filled foundation configurations optionally together with light-weight concrete, and use of light-weight building materials in the building on top tends to provide a buoyant structure in relation to the ground if liquefied. The rotationally moulded house that is intended as a building to accompany this foundation is inherently lighter than other methods of construction. This invention provides a foundation with a complete reinforced, lower plane surface separated from a complete reinforced, upper plane surface by end beams or ribs, made in reinforced concrete. The strong foundation rests upon a substrate which might become unstable. One version is adapted for a house constructed in one or more plastics materials by a rotary moulding process. The circular wall plus ceiling, and floor profiles as moulded can be cut in half and spaced apart by flat sections to elongate the structure. This is shown in FIG. 1 where the approximately circular end or perimeter walls or edge beams 101 and 102 of the foundation structure 100 are optionally separated by a rectangular part 103. Intermediate internal walls 105, 105a and 106 cross the foundation structure. They contribute to the strength of the structure in part by assisting the end walls 101, 102, 101a, 102a in maintaining the space within (203). Included steel rods are shown as dashed lines in FIGS. 1 and 1a, and in FIG. 3 as 301. FIG. 1 also shows the extent of a steel mesh 104 as shown in detail in FIG. 3 as 104 and 104a. The foundation as shown in FIGS. 2 and 3 includes a broad, rigid lower surface 202 and a broad rigid upper surface 201 located above the lower surface. The surfaces are separated by a gap or space 203a, 203b, 203c; the gap or space being surrounded and bridged by rigid ribs 105, 106 and an edge beam 101 and 102. One, non-limiting example of the gap or space height is 220 mm. In another option 100a as shown in plan view FIG. 1a, rectangular 155 edge beams 101a, 102a are provided for a conventional building. As a variation, a polygon shape may replace a circular profile at each end, such as two half-octagons. These may be easier to construct with wooden boxing and on-site facilities for bending reinforcing iron.

The following description assumes on-site construction although prefabrication at a factory is an equally likely option. Steel mesh, for instance “standard type 665” a square-pattern mesh sheet of 5.3 mm diameter rods, welded at 150 mm centres is included within the entire area of the broad, rigid lower surface, which will be poured to a depth of preferably 100 mm thickness according to relevant regulations. Bar stools 303 or the like are used to lift and maintain the steel mesh at least a minimum distance above the substrate and into the concrete, as required. Steel reinforcing rods typically 15 mm diameter as per regulations are placed within perimeter walls and within the internal ribs that serve as space separating means. Since the pouring process includes the entire base, it is likely that the horizontal bars will need to be supported before and shortly after pouring by support means which rise from the substrate, as is well known in the art. Ducts and pipes for services may be included.

A number of ties 302 are threaded through the steel mesh and left with open ends upward for the purpose of penetrating, and then tying down blocks of foam, for instance a “geotech” grade of polystyrene foam 203a which has thermal insulation properties over the top of the poured lower surface. The blocks (or tanks see later) will tend to float up within the wet concrete before it has set and should be held in place. It is unlikely that the blocks can be put in place until after the lower surface has been poured, worked or agitated, and checked for integrity. The preferred block and rib height is dependent on optimisation calculations or local regulations, but may be 220 mm, such that the finished foundation has a total height of 420-500 mm.

After the external (perimeter) walls and internal walls have been poured around the foam blocks, a top-surface layer of steel mesh 104a can be placed over the foam blocks, and supported over the blocks by further “bar stools” or similar supports. The broad, rigid upper surface of reinforced concrete 201 is then poured, agitated and worked to an acceptable finish. It is desirable that all concrete is poured sufficiently simultaneously that the entire foundation fuses into a single mass of concrete. Designs and procedures should ensure that shrinkage due to the curing process does not cause the concrete to, for example, separate along layers representing interfaces between different layers and so provide weakness or routes for ingress of water causing rust. Because of unavoidable shrinkage and possible crack formation, no single poured piece should be too large. The ribs, the edge beam, the lower surface and the upper surface have inherent compressional strength, being made of normal or light-weight concrete and tensile strength thanks to included tensile members (steel rods 301, mesh 104).

To make internal tanks such as for holding water or other liquids (see later) the “geotech” foam could be dissolved out with a solvent after the concrete has cured, or more preferably a metal or plastics tank is embedded within the foundation structure at the time of pouring.

For factory assembly, processes such as cutting, bending and tying reinforcing steel, holding foam pads in place, and pouring of concrete could be made a great deal faster and simpler by the use of jigs and appropriate machinery and an assembly-line approach. This is facilitated by adopting a standard building module, or at least a small range of modules, to be catered for. The foundation pads remain under factory supervision and are kept damp while the concrete is taken through at least the first one or two weeks of curing, so that their strength can be assured and so that work on site is not held up by curing. Applicable building codes must be followed and standard codes may be extrapolated as required in the event that they do not anticipate a light-weight building placed on top. As with ordinary rib raft structures, it is useful to provide sufficient strength to withstand the floor loading of at least a wheel of a light truck when driven over the cured foundation and on top of a filled space.

The invention anticipates deliberate lifting and transport of the foundation by suitable lifting machinery, and for that purpose suitable external couplings are optionally incorporated into the steel such as 108 may be included. A preferred external coupling comprises for example two lengths of optionally stainless steel, or steel wire rope or galvanized strip steel; one passing horizontally along each internal dividing wall, and each length having a ferrule at each end. A crane may lift the foundation by the four ferrules, for example to totally remove the foundation (and the plastics house on top) if it had been provided to an occupant on a temporary basis such as for a refuge. Another reason is to lift the foundation temporarily for re-packing of the substrate below—such as adding more heavy grade metal in the event of further settling of the substrate—and then to return the foundation and building on top, now leveled, to its place. Appropriate selection of type and amount of materials, and on-site preparation, as known to those skilled in the arts, is required; taking into account expected local soil movements of any cause. For example, a substrate comprising a bed of heavy grade metal over the area, perhaps 500 mm deep is laid down and compacted. A portion of the bed is shown as 204 in FIG. 2. This thickness should survive catastrophic loss of soil strength and provides a base to repack the foundation if necessary. This substrate is preferably covered with a sheet of polythene as a damp course. Although the ribs of a prior art rib raft foundation may sink into the substrate the flat base of this foundation will not. If exposed to strong horizontal seismic movement this foundation may slide about over the substrate surface, but will not dig in.

In the event that a dwelling comprises more than one unit rotationally moulded building, an option is to place each unit building on a separate rigid foundation and to use a flexible weatherproof coupling between the buildings as part of an interconnecting hallway. Then each foundation can settle on its own and exhibits a greater strength for a given amount of material than would a single larger foundation. Each foundation may be separately re-packed with minimal disruption if the discrepancy between the two foundations becomes too large.

If soil movements from any cause are expected then all pipes and cables buried within the foundation may be brought to a termination site on a house wall, and connected, preferably by flexible couplings to external services, so that rupture and subsequent leakage does not occur, and so that the entire structure can be transported to another site and there connected to external services. Such services include potable water, sewage, storm water, electricity, cable, telephone, and gas. The sewage line may be pumped, or an outhouse used. Optionally the termination site also includes metering means such as a water and an electricity meter. In some cases, all services within the building can be carried within cabling or piping that is installed above or beside the foundation.

Because the broad, rigid lower surface and the broad rigid upper surface are spaced apart by the gap or space which is bounded by rigid space separating means, the strength of the entire assembly has been calculated as if it was a beam or girder. These calculations assumed that a standard rib raft structure is modified by adding a second surface in contract with the substrate, beneath an upper flat sheet or surface comprising 100 mm thickness concrete including the usual tensile reinforcing material namely one sheet of 665 mesh, separated by vertical concrete ribs 220 mm high and 100 mm wide, with one HD12 rod along each rib adjacent the upper mesh and one rod adjacent the lower 665 mesh, which is included within the lower sheet or surface 202 also comprising 100 mm thickness concrete. Ribs were spaced 1100 mm apart. Calculations show that:
1. The foundations are 1.95 times stronger, at 23.3 kNm, in positive moment bending, and 5.7 times stronger in negative moment bending (as occurs during soil heave) than standard rib raft foundations for which positive strength is 11.96 kNm, and negative 250 strength is 4.10 kNm.
2. The edge beam (around the periphery of the structure) is 2.9 times stronger in positive moment bending and 2.55 times stronger in negative moment bending (soil heave) than the edge beam of a standard rib raft structure.
3. A rib section is 5.05 times stiffer than conventional rib raft foundations. Therefore observed deflections will be only 20% as great as those seen in conventional rib raft structures.
4. The edge beam is 3.1 times stiffer than that of a conventional rib raft foundation. Deflections will be 32% or less of those experienced by a conventional rib raft.

### EXAMPLE 2

This example describes a moulded plastics foundation having a similar design to that of Example 1: a broad upper surface, a broad lower surface, with perimeter walls and internal ribs separating the two, in order to provide significantly greater strength than that of existing foundations. In some past rotationally moulding houses no floor structure at all was provided. In this example the foundation is preferably made by in one or several parts by a similar process of rotational moulding using a thermoplastics material in a rotating mould heated from the exterior. Since the plastics material has inherent tensile strength, embedded tensile reinforcing is not normally required.

In FIG. 4 a vertical section of a rotationally moulded house 400 according to previous patent applications is shown, the house being fastened to a foundation 401 according to the invention and including one or more built-in spaces, which may serve as tanks 402, 403, 404 by fasteners 410. Tanks may be used for storage of any liquid compatible with the tank walls, such as water (in 404). An illustrative tap 404a is included. A lifting pump might be required. In some versions the water is left undisturbed as a heat storage medium, to reduce night-to-day differences. Addition of an antifreeze might be useful. Space 403 is shown in this example as being filled, in another option, with a solid yet light material; for example a relatively dense polystyrene foam. The softening or melting point of the foam is preferably higher than any temperature reached during rotational moulding, although for concrete the melting point does not matter. In this section, item 407 is one of a number of rods or pipes or other incompressible structures serving to carry a pressure applied to the floor of the house 400 through the space 402 and to the substrate beneath.

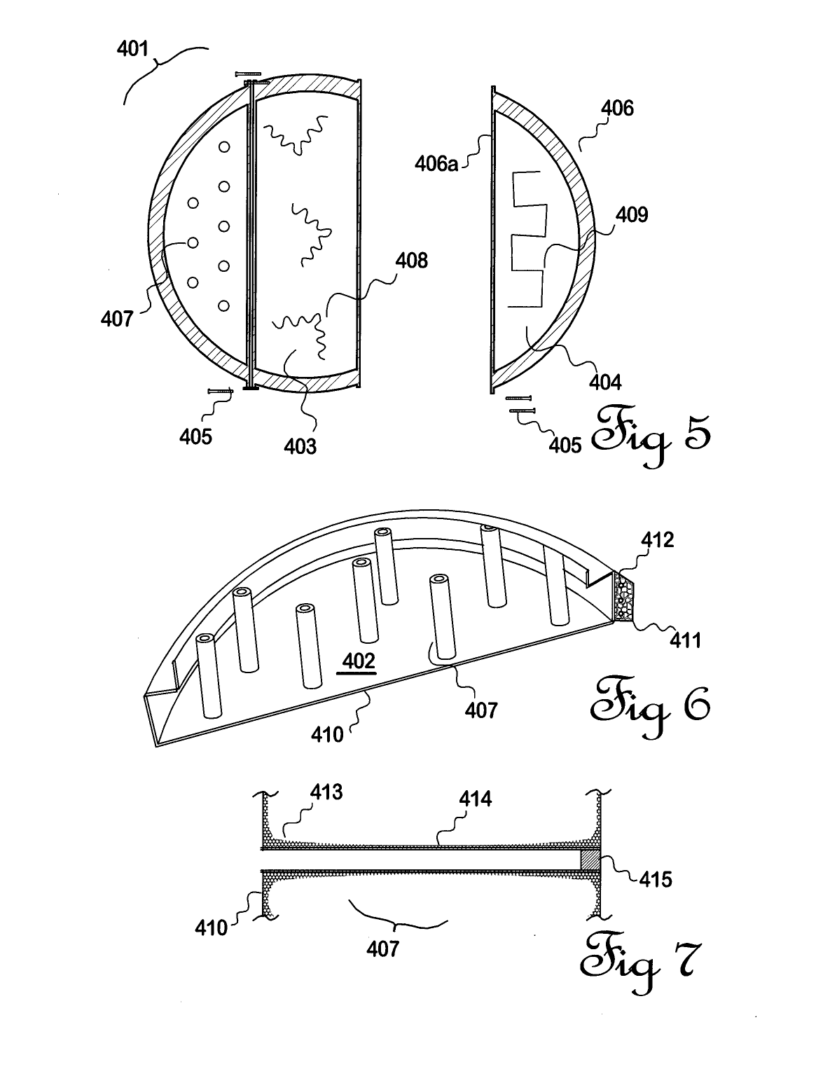

FIG. 5 is a plan view of an Example 2 type foundation including three tanks 402, 403, 404 sharing an overall shape compatible with a rotationally moulded house having a round plan. For use in cold areas, an under-floor tank may include a foam base so that the contents of the tank are less liable to freeze. Such a variant is made by temporarily holding a foam base on to the underside of a prefabricated tank before moulding or casting begins.

Foundations may be constructed as more than one separate foundation module (as 404 is shown here). Any one module may be attached to other modules along preferably vertical surfaces by suitable fastening means 405 at the time of installation. Alternatively the entire foundation may be moulded in one pass. Optionally, only one part of the foundation may be provided with an accessible tank (for example 404 with tap 404a). The modules may be hemispherical (two ends) and rectangular (one or more central sections) in order to comply with the outline of an extended rotationally moulded building. Modules could be moulded as sectors of a circle, so that 6 or 8 sectors are brought together to form a complete circle. One or more transverse vertical barriers may be included within a mould. In this Example, the gap or space is laterally surrounded by rigid surface separating means; a perimeter wall 406, serving to maintain the upper surface separated from the lower surface. Internal walls 406a and internal spacers 407 (rods or pipes), 408 (corrugated metal) or 409 (bent metal) are examples of spacers that transmit downward forces. FIG. 6 is a perspective cutaway view of a stiffened flattish tank 402 according to Example 2, including protrusions such as a series of short rods or pipes 407 used as vertical load-bearing structures, reaching from the interior bottom to the interior top of each tank. These structures transmit loads placed upon the upper surface through the tank to the lower surface, then on to the substrate. The supports have the effect of reducing flexure of the upper surface when loaded such as by foot pressure from walking people. Dividing walls also comprise weight-bearing members. FIG. 6 also includes an optional surround of a solid material 411 such as concrete, tamped earth, dried mud, asphalt, or other local, settable materials, optionally including ropes or curved rods 412 under tension, serving as a border around the periphery of a rotationally moulded house and to retain the side walls of the foundation and tank 410.

FIG. 7 is a longitudinal section through one such protrusion or pipe. Note that the thermoplastics moulding material 413 is drawn as having coated the length of the pipe 407 more thickly around each end. The coating in the centre may be thin and possibly imperfect, on account of the way that the granules move during a rotational moulding process.

An innovative moulding process provides that tanks like 402, including internal pipes, can be moulded in one operation. Prior to moulding, thermally conductive metal rods or pipes (not shown) are held within the two halves of the mould (not shown) which includes a set of aligned perforations. The rods or pipes carry heat in an amount sufficient to ensure that thermoplastics moulding material 413 will stick to the exposed surfaces of each rod or pipe within the mould. Note that the thermoplastics moulding material 413 is drawn as having coated the length of the pipe 407 more thickly around each end. The coating in the centre may be thin and possibly imperfect. It has been found that if a sacrificial plastics pipe 414 having a selected softening temperature such that it will bond with the selected thermoplastics powder but not collapse during moulding is placed over each conductive rod before the mould is closed then the thermoplastics granules will effectively seal around the ends of the pipe even if the coating is thin or incomplete in the centre. The set of plastics pipes 407 carry a transmitted force, while the tank is rendered water tight by the bonding that occurs at least towards each end of each sacrificial pipe. At the end of the manufacturing process, each thermally conductive metal rod or pipe is pulled out after parting between the metal and the plastic, and the upper end of each pipe is plugged (note plug 415) flush with the exposed surface. The tank is then checked. Alternatively, each pipe may be pre-coated with a layer of moulded thermoplastics material, and tested, before being installed inside the mould.

In an option, a physical tank made of a heat-resistant material—at least resistant to heat at the forming temperature used for the rotational moulding process—is embedded within the thermoplastics material at the time of manufacture. Options for the tank walls include thermosetting plastics, thermoplastics having a high softening point, such as polyethylene terephthalate (PET or “Mylar®”), or metal tanks. Each tank could be made by rotational moulding or could be made by welding sheet materials and may be made in sectors or tangents of a circle rather than the full diameter (up to about 5 metres) of an entire building.

### OPTIONS AND INDUSTRIAL ADVANTAGES

The foundation of this invention is a light yet strong unit that can withstand bending and twisting forces to a greater degree than previous foundation pads.

This foundation is optimised for use with a rotationally moulded house, but the principles may be applied more widely.

Foundations and housing made as described in this specification may be constructed at a factory, cured before delivery, and trucked to a site at which a compacted substrate of sufficient dimensions has been made, and erected by persons with very little if any skill.

If the foundation is assembled at a factory it may be possible to mount the rotationally moulded building on top at the same time, so that very little on-site work remains.

This foundation can be lifted up by a crane or other lifting machine and the underlying substrate may be augmented if subsidence or further settling of the substrate occurs.

Housing made with this invention is able to be taken down after an emergency is over, stored in a compacted form, and re-used in response to a later emergency situation.

Finally it will be understood that the scope of this invention as described and illustrated herein is not limited to the specified embodiments. Those of skill will appreciate that various modifications, additions, known equivalents, and substitutions are possible without departing from the scope and spirit of the invention as set forth in the following claims.

What is claimed is:

1. A foundation comprised of one or more modules for a building is characterised in that the or each module includes a broad, rigid, reinforced lower surface having, when in place, an exposed lowest face and an interior face, upon which surface are simultaneously moulded or cast at least one rigid separating means selected from a range including peripheral beams, internal vertical protrusions and transverse ribs, all sharing a common height thereby determining the height of at least one space enclosed within the foundation, and upon which separating means a broad, rigid, reinforced upper surface is simultaneously moulded or cast; the upper surface having an interior face and an uppermost exposed face; the or each module including attachment means for attachment to other modules and supported buildings.

2. A module for a foundation as claimed in claim 1; characterised in that the foundation is comprised of more than one module fastened together by attachment means along exposed sides in order to form a larger total surface area.

3. A module for a foundation as claimed in claim 1; characterised in that at least some modules are provided with lifting attachments capable of being used to lift the foundation and a building attached thereupon.

4. A module for a foundation as claimed in claim 1; characterised in that the or each enclosed space is sealed thereby forming a tank, and is provided with a sealable aperture in order that the tank may be filled and emptied with a fluid.

5. A module for a foundation as claimed as claimed in claim 4; characterised in that a previously manufactured tank is sealed into the enclosed space.

6. A module for a foundation as claimed in claim 1; characterised in that the or each enclosed space is filled with an inert, foamed material.

7. A module for a foundation as claimed in claim 1; characterised in that each module is made of poured concrete, the lower surface, upper surface, and rigid separating means being reinforced by provision of internal, elongated metal rods in order to provide a tensile strength.

8. A module for a foundation as claimed in claim 1; characterised in that the first and the second surfaces and said at least one rigid separating means are comprised of a rotationally moulded plastics material and the first and the second surfaces and the separating means are moulded as a single unit.

9. A module for a foundation as claimed in claim 8 characterised in that the or each space having a height is traversed by at least one internal rigid member capable when in use of transmitting a load from the upper surface to the lower surface.

10. A module for a foundation as claimed in claim 7; characterised in that the foundation includes one or more termination sites at which external services selected from a range including potable water, sewage, storm water, electricity, cable, telephone, and gas may be reversibly connected.

11. A method for including said at least one internal rigid beam within a rotationally moulded module for a foundation as claimed in claim 9 characterised in that the method includes the steps of providing or performing:
a) a mould for the module having two shells; each shell including a plurality of matching apertures; one at the site of each internal rigid beam,
b) a conductive metal rod of greater length than the height of the final internal space; one to be placed through each aperture in one shell of the mould,
c) a thermoplastics plastic pipe having a selected softening temperature such that it will bond with the selected thermoplastics powder and a length equal to the height of the internal space is placed over each conductive metal rod inside the mould,
d) closing the two shells of the mould while ensuring that the conductive metal pipes are exteriorised through corresponding apertures in both shells,
e) rotating the mould within a heated oven, so that an inserted mass of thermoplastics powder will fuse together over the interior of the mould and fuse with the thermoplastic pipes and form an enclosed module inside the mould, having an internal space bridged by a plurality of closed plastics pipes, and
f) parting the mould after cooling has occurred, removing the metal rods for re-use, and removing the module from the mould.

12. A module for a foundation as claimed in claim 8; characterised in that the foundation includes one or more termination sites at which external services selected from a range including potable water, sewage, storm water, electricity, cable, telephone, and gas may be reversibly connected.
